(19) United States
(12) Patent Application Publication
(10) Pub. No.: US 2006/0100338 A1
(43) Pub. Date: May 11, 2006

(54) Pigment composition

(75) Inventors: Kjell Rune Andersson, Goteborg (SE); Joakim Carlen, Goteborg (SE); Erik Lindgren, Bohus (SE)

Correspondence Address: AKZO NOBEL INC.;INTELLECTUAL PROPERTY DEPARTMENT, 7 LIVINGSTONE AVENUE, DOBBS FERRY, NY, 10522-3408, US

(73) Assignee: AKZO NOBEL N.V., Arnhem (NL)

(21) Appl. No.: 11/267,756

(22) Filed: Nov. 3, 2005

Related U.S. Application Data
(60) Provisional application No. 60/629,810, filed on Nov. 9, 2004.

(30) Foreign Application Priority Data
Nov. 8, 2004 (EP) 04105595.5

(51) Int. Cl. C08K 3/34

(52) U.S. Cl. 524/442; 524/492

(57) ABSTRACT

The present invention relates to a pigment composition in the form of an aqueous dispersion comprising: (d) pigment particles of synthetic amorphous silica or aluminosilicate; (e) at least one water soluble aluminium salt; and, (f) at least one cationic polymer having a molecular weight from about 2000 to about 1000000 and a charge density from about 0.2 to about 12 meq/g. The invention further relates to a process for its production, use thereof, a process for coating paper or paper board and paper or paper board obtainable by the process.

This application claims priority based on European Patent Application No. 04105595.5, filed on Nov. 8, 2004 and on U.S. Provisional Patent Application No. 60/629,810, filed Nov. 9, 2004.

The present invention relates to a pigment composition and a process for its production, use thereof, a process for coating paper or paper board and paper or paper board obtainable by the process.

### BACKGROUND OF THE INVENTION

The development of ink-jet printers has led to a demand for paper that is suitable for that purpose. Particularly, there is a demand for paper that is simple to produce but still enables ink-jet printing of high quality.

It has been disclosed to use various kinds of coatings to produce paper suitable for ink-jet printing.

US Patent Application Publication 2002/0039639 discloses incorporating a water soluble metal salt in an ink receiving layer comprising pigments and a conventional binder.

U.S. Pat. No. 4,554,181 discloses a recording surface including a combination of a water soluble polyvalent metal and a cationic polymer.

US Patent Application Publication 2004/0255820 discloses a pigment that is surface treated with a water-soluble polyvalent metal salt.

US Patent Application Publication 2005/0106317 discloses a method for preparing an ink-jet recording material comprising the steps of forming at least one porous layer containing silica particles with an average secondary particle size of 500 nm or less, and coating a coating solution for preparing an inorganic particles-containing layer so that a solid content of the coated inorganic particles became 0.33 g/m² or less on the porous layer.

U.S. Pat. No. 6,797,347 discloses an ink-jet paper comprising a base paper and a coating thereon, wherein said coating contains an inorganic pigment modified with a positively charged complex and a binder. The positively charged complex contains a polyvalent metal ion and an organic ligand.

US Patent Application Publication 2003/0099816 discloses an ink jet-recording material comprising a substrate and a transparent ink-receiving layer comprising a binder and a plurality of particles formed by dispersing amorphous silica particles and applying a strong mechanical stress to divide the particles.

Other examples of disclosures relating to coated paper are WO 03/011981, WO 01/53107, WO 01/45956, EP 947349, EP 1120281 EP 1106373 and U.S. Pat. No. 5,551,975.

It is an object of the invention to provide a pigment composition suitable for coating paper or paper board for ink-jet printing and that is simple to produce.

It is another object of the invention to provide a coating formulation that is simple to apply on the surface of paper or paper board to make it suitable for ink-jet printing.

It is still another object of the invention to provide a paper or paper board suitable for ink-jet printing that is simple to produce.

### SUMMARY OF THE INVENTION

It has been found that the objects can be achieved by a novel pigment composition. Thus, one aspect of the invention concerns a pigment composition in the form of an aqueous dispersion comprising:
(a) pigment particles of synthetic amorphous silica or aluminosilicate;
(b) at least one water soluble aluminium salt; and,
(c) at least one cationic polymer having a molecular weight from about 2000 to about 1000000 and a charge density from about 0.2 to about 12 meq/g.

### DETAILED DESCRIPTION OF THE INVENTION

The pigment particles of synthetic amorphous silica or aluminosilicate preferably have a mean diameter from about 0.005 μm to about 25 μm, more preferably from about 0.007 μm to about 15 μm, most preferably from about 0.01 μm to about 10 μm. The particles preferably have a surface area from about 30 m²/g to about 600 m²/g, more preferably from about 30 to about 450 m²/g, most preferably from about 40 m²/g to about 400 m²/g particularly most preferably from about 50 m²/g to about 300 m²/g. The net surface charge of the pigment particles in the composition is preferably positive, the dispersion thus being regarded as predominantly cationic.

The term diameter as used herein refers to the equivalent spherical diameter.

The pigment particles of synthetic amorphous silica or aluminosilicate may, for example, be precipitated silica, gel-type silica, fumed silica, colloidal primary particles of silica, aluminosilicate or a mixture thereof, or porous aggregates formed by aggregation of colloidal primary particles of silica, aluminosilicate or a mixture thereof in an aqueous sol, or a mixture of one or more of the above kinds of particles.

Precipitated silica refers to silica formed when ultimate silica particles in an aqueous medium are coagulated as loose aggregates, recovered, washed, and dried. Precipitated silica is commercially available, for example under the trademark Tixosil™.

Gel-type silica refers to particles formed from a silica gel (usually described as a coherent, rigid three-dimensional network of contiguous particles of colloidal silica). Gel-type silica is commercially available, for example under the trademark Sylojet™.

Fumed silica refers to silica prepared by a flame hydrolysis method. Fumed silica is commercially available, for example under the trademarks Cabosil™ and Aerosil™.

Colloidal primary particles of silica or aluminosilicate have preferably been formed from an aqueous solution of alkali metal silicate where alkali metal ions are removed through an ion exchange process or where the pH of the alkali metal silicate solution has been reduced by the addition of an acid. A process based on ion exchange follows the basic principles described in R. K. Iler, “The Chemistry of Silica” 1979, pages 333-334 and results in an aqueous sol comprising colloidal negatively or positively charged particles of silica or aluminosilicate. A process based on pH-reduction of alkali metal silicate follows the basic principles described in e.g. U.S. Pat. Nos. 5,176,891, 5,648,055, 5,853,616, 5,482,693, 6,060,523 and 6,274,112.

Particularly preferred sols comprise colloidal primary particles of silica that may or may not be surface modified, for example with a metal oxide such as oxide of aluminium, titanium, chromium, zirconium, boron or any other suitable metal.

The surface area of the primary particles is from about 30 m²/g to about 600 m²/g, more preferably from about 30 to about 450 m²/g, most preferably from about 40 m²/g to about 400 m²/g particularly most preferably from about 50 m²/g to about 300 m²/g. The dry content of the aqueous sol of primary particles is preferably from about 0.5 wt % to about 60 wt %, most preferably from about 1 wt % to about 50 wt %.

Suitable aqueous sols of colloidal primary particles of silica or aluminosilicate are commercially available, for example under the trademarks Ludox™, Snowtex™, Bindzil™, Nyacol™, Vinnsil™ or Fennosil™.

Unlike a sol formed by dispersing a powder of e.g. precipitated silica, gel-type silica or fumed silica, the colloidal particles in a sol prepared from alkali metal silicate by ion exchange or pH-reduction have never been dried to a powder, such as in the case for e.g. precipitated silica or gel-type silica.

In the case the particles in the composition are aggregates of colloidal primary particles, the mean particle diameter of these primary particles is preferably from about 5 nm to about 125 nm, most preferably from about 7 nm to about 100 nm. The colloidal primary particles are preferably in the form of an aqueous sol as described above.

Aggregation of primary particles in a sol to form a dispersion of porous aggregates may be performed with any suitable method, such as those described in R. K. Iler, “The Chemistry of Silica” 1979, pages 364-407. The degree of aggregation can be followed by measuring the viscosity and applying the Einstein and Mooney equations (see e.g. R. K. Iler, “The Chemistry of Silica” 1979, pages 360-364). The aggregation may be performed as a separate step or in a mixture also comprising other pigment particles.

In one embodiment, an anionic sol (comprising negatively charged colloidal primary particles) and a cationic sol (comprising positively charged colloidal primary particles) are mixed, resulting in the formation of porous aggregates of primary particles from both the sols.

In another embodiment a salt, preferably selected from divalent, multivalent or complex salts, is added to an anionic or cationic sol also resulting in the formation of porous aggregates. Examples of salts are aluminium chloride, poly aluminium chloride, poly aluminium silicate sulfate, aluminium sulfate, zirconium carbonates, zirconium acetates, alkali metal borates, and mixtures thereof.

In still another embodiment a bridging substance is used to form the aggregates from the primary particles. Examples of suitable bridging substances are synthetic and natural polyelectrolytes such as CMC (carboxymethyl cellulose), PAM (polyacrylamides), polyDADMAC (poly diallyl dimethyl ammoniumchloride), polyallyl amines, polyamines, starch, guar gums, and mixtures thereof.

Any combination including one, two or all three of the above aggregation methods can also be employed.

Each porous aggregate is formed from at least three primary particles, which inherently gives at least some pores. The mean particle diameter of the aggregates is preferably from about 0.03 to about 25 μm, more preferably from about 0.05 to about 10 μm, most preferably from about 0.1 μm to about 5 μm. It is to be understood that the average diameter of the porous aggregates is always larger than the average diameter of the primary particles they are formed from. The surface area of the aggregates is usually essentially the same as of the primary particles.

In an embodiment the pigment particles of synthetic amorphous silica or aluminosilicate is a mixture of colloidal particles in a sol prepared from alkali metal silicate by ion exchange or pH-reduction, optionally partially or fully aggregated, with particles of one or more of precipitated silica, gel-type silica or fumed silica.

The water soluble aluminium salt in the pigment composition can be any aluminium containing salt and is preferably present in an amount from about 0.1 wt % to about 30 wt % most preferably from about 0.2 wt % to about 15 wt %, calculated as wt % Al₂O₃ on dry pigment particles. Examples of salts include aluminium chloride, poly aluminium chloride, poly aluminium silicate sulfate, aluminium sulfate, zirconium carbonates, zirconium acetates, and mixtures thereof. The aluminium may be present partly or fully on the surface of the particles of silica or aluminosilicate or in the aqueous phase.

The entire content of water soluble aluminium salt may originate from what is present in a cationic aluminium modified silica sol used for preparing the pigment composition. However, the pigment composition may also comprise additional aluminium salt.

The cationic polymer in the pigment composition has a molecular weight from about 2000 to about 1000000, preferably from about 2000 to about 500000, most preferably from about 5000 to about 200000. The charge density is from about 0.2 meq/g to about 12 meq/g, preferably from about 0.3 meq/g to about 10 meq/g, most preferably from about 0.5 meq/g to about 8 meq/g. The cationic polymer is preferably present in the pigment dispersion in an amount from about 0.1 wt % to about 30 wt %, more preferably from about 0.5 wt % to about 20 wt %, most preferably from about 1 wt % to about 15 wt %, based on the amount of dry pigment particles. Examples of suitable cationic polymers include synthetic and natural polyelectrolytes such as PAM (polyacrylamides), polyDADMAC (poly diallyl dimethyl ammoniumchloride), polyallyl amines, polyamines, polysaccharides and mixtures thereof, provided that the molecular weight and charged density fulfil the above requirements. The cationic polymer may be present partly or fully on the surface of the particles of silica or aluminosilicate or in the aqueous phase.

In an embodiment the composition further comprises other kinds of pigment particles such as kaolinites, smectites, talcites, calcium carbonate minerals, precipitated calcium carbonate, and mixtures thereof. The content of synthetic amorphous silica or aluminosilicate particles is preferable from about 10 to 100 wt %, most preferable from about 30 wt % to 100 wt % of the total amount of pigment particles.

The total content of pigment particles of synthetic amorphous silica or aluminosilicate and optional other pigment particles in the composition is preferably from about 1 wt % to about 60 wt %, most preferably from about 5 wt % to about 50 wt %, particularly most preferably from about 10 wt % to about 50 wt %.

The pigment composition may also comprise a coating binder suitable for paper coating, preferably in an amount 0 to about 70 wt %, most preferably from 0 to about 50 wt %, based on total amount of pigment particles. Examples of such binders conventionally used in paper coating are polyvinyl alcohols, optionally modified starches, gums, protein binders (e.g. caseins and soy protein binders), latices and mixtures thereof. Latices can be based on styrene butadien, acrylates, vinyl acetate, co-polymers of ethylene and vinyl acetates, styrene acrylic esters etc. If one or more binders are included, polyvinyl alcohols are particularly preferred.

The pigment composition may also comprise other additives commonly used for paper coating such as stabilisers, rheology modifiers, optical brighteners, lubricants, insolubilizers, dyes, sizing agents etc, as well as various impurities from the raw materials. The dry content of the pigment composition is preferably from about 2 wt % to about 75 wt %, most preferably from about 10 wt % to about 70 wt %. The total amount of other additives (apart from optional binders) and possible impurities is preferably from 0 to about 50 wt %, most preferably from 0 to about 30 wt %, based on the dry content.

A pigment composition as described above is preferably storage stable for at least one week, most preferably at least one month. The composition may be used directly for coating paper or paperboard or form an intermediate product for preparing a coating composition.

It has been found that a composition comprising pigment particles of optionally aggregated primary particles of silica or aluminosilicate with a low surface area, preferably below 450 m²/g, and prepared from alkali metal silicate by ion exchange or pH-reduction as earlier described, satisfactory results can be obtained by coating paper or paperboard with a pigment composition comprising no or only low amounts of a binder as mentioned above, for example less than about 3 wt %, preferably less than about 2 wt % on dry pigment, most preferably less than about 1 wt % binder of the total amount of pigment particles.

The invention further relates to a process for the production of a pigment composition as described above comprising mixing particles of synthetic amorphous silica or aluminosilicate, a water soluble aluminium salt and a cationic polymer having a molecular weight from about 2000 to about 1000000 and a charge density from about 0.2 meq/g to about 12 meq/g to an aqueous dispersion in a way so substantial gelling or precipitation is avoided. This can be achieved by several alternative process embodiments.

One alternative process embodiment comprises a step of adding particles of synthetic amorphous silica or aluminosilicate to an aqueous solution of a water soluble aluminium salt, followed by adding a cationic polymer as described above. Other components such as other pigment particles or binders may be added at any stage in the form of solids, liquids or dispersions. The silica or aluminium silicate particles may be in the form of a solid powder or an aqueous sol of colloidal particles, that may be anionic or cationic. Unless a cationic sol is used, the aluminium salt is preferably in such an excess that it is sufficient for rendering the resulting dispersion predominantly cationic. At least if an anionic sol is used, there may be at least some aggregation of the colloidal particles.

Another alternative process comprises a step of adding particles of synthetic amorphous silica or aluminosilicate to an aqueous solution of a cationic polymer as described above followed by adding a water soluble aluminium salt. Other components such as other pigment particles or binders may be added at any stage in the form of solids, liquids or dispersions. The silica or aluminium silicate particles may be in the form of a solid powder or an aqueous sol of colloidal particles, that may be anionic or cationic. Unless a cationic sol is used, the cationic polymer is preferably in such an excess that it is sufficient for rendering the resulting dispersion predominantly cationic. At least if an anionic sol is used, there may be at least some aggregation of the colloidal particles.

Still another process embodiment comprises a step of mixing a cationic aluminium modified aqueous sol of colloidal silica or aluminosilicate with a cationic polymer. Although possible, it is not necessary to add further water soluble aluminium salt apart from what is present in the sol of colloidal silica or aluminosilicate. Other components such as other pigment particles or binders may be added at any stage in the form of solids, liquids or dispersions.

Regarding suitable and preferred amounts and kinds of the components, the above description of the pigment composition is referred to.

The invention also concerns the use of a pigment composition as described above for coating paper or paper board.

The invention further concerns a process for the production of coated paper or paperboard comprising a step of applying a pigment composition as described above as a coating to at least one side of a paper or paperboard web.

The coating is preferably applied in an amount sufficient to yield from about 0.4 g/m² to about 40 g/m², more preferably from about 0.5 g/m² to about 40 g/m², most preferably from about 1 g/m² to about 20 g/m² of pigment particles of synthetic amorphous silica or aluminosilicate and optionally other pigment particles from the pigment composition per coated side of the paper or paper board web. In most cases the dry amount of coating applied per coated side of the paper or paper board is preferably from about 0.7 g/m² to about 50 g/m², most preferably from about 1.0 g/m² to about 25 g/m².

The coating is preferably applied to a non-coated side of the paper or paper board but may also be applied on top of a previously applied coating layer with the same or another coating composition. It is preferred not to apply any further coating of other kind on top of the layer formed from the coating as described herein.

Applying the coating can be performed either on the paper or board machine or off the paper or board machine. In either case any type of coating methods can be used. Examples of coating methods are blade coating, air knife coating, roll coating, curtain coating, spray coating, size press coating (e.g. film press coating) and cast coating.

After applying the coating the paper is dried, which in the case of on machine coating preferably is accomplished in a drying section of the machine. Any means of drying may be used, such as infra red radiation, hot air, heated cylinders or any combination thereof.

The term coating as used herein refers to any method in which pigments are applied to the surface of paper or paper board, thus including not only conventional coating but also other methods such as for example pigmenting.

The paper and paper board to be coated can be made from any kind of pulp, such as chemical pulp like sulfate, sulfite and organosolve pulps, mechanical pulp like thermo-mechanical pulp (TMP), chemo-thermo-mechanical pulp (CTMP), refiner pulp or ground wood pulp, from both hardwood and softwood bleached or unbleached pulp that is based on virgin or recycled fibres or any combination thereof. Paper and paper board from any other kind of pulp may also be coated in accordance with the invention.

Regarding further details and embodiments of the pigment composition, the above description of the same is referred to.

The invention finally concerns paper or paper board suitable for ink-jet printing obtainable by a process as described above. Such paper or paper board comprises a substantially transparent or substantially non-transparent layer comprising pigment particles of synthetic amorphous silica or aluminosilicate and optionally other pigment particles from the coating composition, the pigment particles preferably forming a nano-structure. The dry amount of coating is preferably from about 0.5 g/m² to about 50 g/m², most preferably from about 1.0 g/m² to about 25 g/m². The amount of pigment particles from the above described pigment composition per coated side of the paper or paper board is preferably from about 0.7 g/m² to about 40 g/m², most preferably from about 1 g/m² to about 20 g/m². Preferably no other kind of coating has been applied on top of this layer.

It has been found that the paper or paper board of the invention have particularly good properties for inkjet printing, giving low line blurriness and mottling and high printing density for colours, but can advantageously also be used for other kinds of printing processes like toner, flexography, letter press, gravure, offset lithography and screen printing. It is a particular advantage that such good properties can be obtained in a simple manner by applying only small amounts of the coating and without the need to apply numerous different coating layers on the paper or paper board. This also enable the coating to be applied with a size press, such as a film press, which for practical reasons is advantageous. Furthermore, the main components of the pigment composition can be made from readily available raw materials.

The invention will now be further described in following examples. Unless otherwise stated all parts and percentages refer to parts and percent by weight.

### EXAMPLE 1

Three coating formulations with a gel-type silica pigment, Sylojet™ P612 from Grace Davison, were prepared. In all three formulations a polyvinyl alcohol binder (ERKOL™ 26/88 from ACETEX Co., Spain) was used as the binder. The polyvinyl alcohol (PVA) was dissolved in water at 90° C. to a concentration of 10 wt % and was added in an amount to give 20 parts binder (dry) to 100 parts silica pigment (dry). The total content of pigment particles in the three coating formulations were 20 wt %.
A) 20 g 10 wt % PVA solution was diluted with 20 g water. 10 g of dry powder Sylojet™ was slowly added to the solution under vigorous mixing in an UltraTurrax™, (10 000 rpm).
B) In one beaker 10 g of Sylojet™, 20 g 10 w t % PVA and 10 g water were mixed as in A. In another beaker 3 g of aluminium chlorohydrate, Locron™ from Clariant (25 wt % Al₂O₃) was diluted with 7 g water. Under UltraTurrax™ mixing the PVA-Sylojet™ slurry was slowly added to the Locron™ solution.
C) In one beaker a Sylojet-PVA slurry was prepared as in B. In another beaker 3 g Locron™ was diluted with 3.5 g water and Sylojet™-PVA slurry was mixed with the Locron™ solution as in B. Finally 1.5 g polyDADMAC (40 wt %, molecular weight 20 000 and charge density of 7.2 meq/g), was diluted with 2 g water and added to the Sylojet™-PVA-Locrom™ slurry.

The three coating formulations were applied on surface of an uncoated copy paper (A4 sized Data Copy from M-real) by a drawdown method with a wired rod as commonly used in laboratory coating tests. After the coating the paper was dried with an IR-dryer (Hedson Technologies AB, Sweden). The dried sheets of papers were evaluated on two inkjet printers, HP Deskjet™ 5850 from Hewlett-Packard and Epson Stylus™ C86 from Epson.

The print results were evaluated using a print picture with seven colour blocs: cyan, magenta, yellow, red, green, blue and black. The printed blocs and the unprinted paper were measured with a spectrophotometer (Color Touch 2 from Technidyne) and the colour gamut volume was calculated. The gamut volume is approximated with a dodecahedral in the CEI L*a*b* colour space and the measurements of the colours give the corners in the dodecahedral (see “Rydefalk Staffan, Wedin Michael; Litterature review on the colour Gamut in the Printing Process-Fundamentals, PTF-report no 32, May 1997”). The results are shown in the table below:

| Coating | Coat Weight | Gamut Volume | Gamut Volume |
|---|---|---|---|
| Formulation | (g/m²) | Epson | HP |
| A | 6.7 | 254667 | — |
| A | 6.5 | — | 269787 |
| B | 7.4 | 259508 | — |
| B | 7.7 | — | 268188 |
| C | 7.1 | 259055 | — |
| C | 7.1 | — | 280154 |

It can be seen that coating formulation C gave the best over-all colour gamut. A visual judgement also revealed good line sharpness and no tendency of colour mottling.

### EXAMPLE 2

In these formulation pigment blends with equal parts (dry/dry) of the gel-type silica used was Sylojet™ P612 (same as in Example 1) and an anionic silica sol, Nyacol™ 9950 from Eka Chemicals, a 50 wt % sol with a mean particle size of 100 nm. As binder the same amount and the same kind of PVA as in Example 1 was used. Two coating formulations with a total pigment content of 20 wt % were prepared.
A) 5 g dry silica gel (Sylojet™ P612) was dispersed in solution containing 10 g Nyacol™ 9950, 20 g 10 wt % PVA and 15 g water under UltraTurrax™ mixing (10 000 rpm).
B) In one beaker 5 g dry silica gel (Sylojet™ P612) was dispersed in solution containing 10 g Nyacol™ 9950 and 20 g 10 wt % PVA under UltraTurrax™ mixing (10 000 rpm). In another beaker 3 g Locron™ was mixed with 7 g water. The slurry in the first beaker was then transfer to the Locron™ solution under UltraTurrax™ mixing and thereafter 1.5 g of polyDADMAC (same as in example 1) was added after prior dilution with 3.5 g water.

Following the same procedure as in Example 1, the coatings were applied to paper and dried and evaluated on two printers. The results are shown in the table below:

| Coating | Coat Weight | Gamut Volume | Gamut Volume |
|---|---|---|---|
| Formulation | (g/m²) | Epson | HP |
| A | 6.7 | 215034 | — |
| A | 6.7 | — | 263809 |
| B | 7.2 | 246013 | — |
| B | 7.1 | — | 290624 |

It appears that coating formulation B gave better print quality on both the printers.

### EXAMPLE 3

In the test an anionic silica sol, Bindzil™ 50/80 from Eka Chemicals was used as pigment, a 50 wt % sol with a mean particle size of 40 nm. Two formulations were prepared without any PVA-binder.
A) Bindzil™ 50/80 diluted to 30 wt %.
B) 6 g Locron™ was diluted with 20 g water and 60 g of Bindzil™ 50/80 was added under vigorous mixing (UltraTurrax™). The mixing continued during the addition of 3 g polyDADMAC (same as in example 1) and 11 g water. The final concentration of silica became 30 wt %.

Following the same procedure as in Example 1, the coatings were applied to paper and dried (coat weight 8-9 g/m²) and evaluated on two printers. The results are shown in the table below:

| Coating | | Gamut Volume |
|---|---|---|
| Formulation | Gamut Volume Epson | HP |
| A | 262220 | 229017 |
| B | 260601 | 261672 |

It appears that although coating formulation A gave a slightly better gamut volume on Epson, formulation B was significantly better on HP and therefore can be considered as giving best over-all result. A visual judgement also revealed good line sharpness and no tendency of colour mottling.

### EXAMPLE 4

Four coating formulations were prepared. A pigment composition of equal parts (dry/dry) of anionic silica sol, Bindzil™ 50/80 and kaolin a coating clay (SPS™, Imerys, UK) were used in all formulations. As in Example 3 no external binder such as PVA was used in any of the formulations.
A) Bindzil™ 50/80, SPS™ clay and water were mixed in UltraTurrax™ to a pigment concentration of 30 wt %.
B) A pigment slurry containing 15 g Bindzil™ (as dry) and 15 g SPS clay was added to a water solution containing 6 g Locron™ (as is) under UltraTurrax™ mixing and the final pigment concentration became 30 wt %.
C) 3 g polyDADMAC (same as in example 1) was diluted with water and added to a pigment slurry containing 15 g of Bindzil™ (as dry) and 15 g SPS™ clay under Ultra-Turrax™ mixing to a pigment solids of 30 wt %.
D) A pigment slurry was mixed with Locron™ solution as in A. The UltraTurrax mixing continued and 3 g polyDADMAC (same as in Example 1) was diluted with water and added to a Locron treated pigment slurry to obtain a final pigment content of 30 wt %.

Following the same procedure as in Example 1, the coatings were applied to paper and dried (coat weight 8-9 g/m²) and evaluated on two printers. The results are shown in the table below:

| Coating | | Gamut Volume |
|---|---|---|
| Formulation | Gamut Volume Epson | HP |
| No coating | 178288 | 163247 |
| A | 233379 | 177191 |
| B | 253114 | 201548 |
| C | 233987 | 208773 |
| D | 268608 | 211090 |

It appears that coating formulation D, containing both an aluminium salt and a cationic low-molecular polymer, gave best results on both the printers.

1. Pigment composition in the form of an aqueous dispersion comprising:
(a) pigment particles of synthetic amorphous silica or aluminosilicate;
(b) at least one water soluble aluminium salt; and,
(c) at least one cationic polymer having a molecular weight from about 2000 to about 1000000 and a charge density from about 0.2 to about 12 meq/g.

2. Composition as claimed in claim 1, wherein the particles of synthetic amorphous silica or aluminosilicate are selected from the group consisting of precipitated silica, gel-type silica, fumed silica, colloidal primary particles of silica, aluminosilicate or a mixture thereof, porous aggregates formed by aggregation of colloidal primary particles of silica, aluminosilicate or a mixture thereof in an aqueous sol, and a mixture of one or more of the above kinds of particles.

3. Composition as claimed in claim 1, wherein the pigment particles of synthetic amorphous silica or aluminosilicate have a mean diameter from about 0.005 μm to about 25 μm.

4. Composition as claimed in claim 1, wherein the net surface charge of the pigment particles in the composition is positive.

5. Composition as claimed in claim 1, wherein pigment particles of synthetic amorphous silica or aluminosilicate have a surface area from about 30 to about 600 m²/g.

6. Composition as claimed in claim 1, wherein the pigment particles of synthetic amorphous silica or aluminosilicate is a mixture of colloidal particles in a sol prepared from alkali metal silicate by ion exchange or pH-reduction, optionally partially or fully aggregated, with particles of one or more of precipitated silica, gel-type silica or fumed silica.

7. Composition as claimed in claim 1, wherein the at least one water soluble aluminium salt is selected from the group consisting of aluminium chloride, poly aluminium chloride, poly aluminium silicate sulfate, aluminium sulfate, zirconium carbonates, zirconium acetates, and mixtures thereof.

8. Composition as claimed in claim 1, wherein the at least one water soluble aluminium salt is present in an amount from about 0.1 wt % to about 30 wt %, calculated as wt % Al₂O₃ on dry pigment particles.

9. Composition as claimed in claim 1, wherein the at least one cationic polymer is selected from the group consisting of PAM (polyacrylamides), polyDADMAC (poly diallyl dimethyl ammoniumchloride), polyallyl amines, polyamines, polysaccharides and mixtures thereof.

10. Composition as claimed in claim 1, wherein the at least one cationic polymer is present in an amount from about 0.1 wt % to about 30 wt %, based on the amount of dry pigment particles.

11. Composition as claimed in claim 1, wherein the pigment composition further comprises other kinds of pigment particles.

12. Composition as claimed in claim 11, wherein the other kinds of pigment particles are selected from the group consisting of kaolinites, smectites, talcites, calcium carbonate minerals, precipitated calcium carbonate, and mixtures thereof.

13. A process for the production of a pigment composition comprising mixing particles of synthetic amorphous silica or aluminosilicate, a water soluble aluminium salt and a cationic polymer having a molecular weight from about 2000 to about 1000000 and a charge density from about 0.2 meq/g to about 12 meq/g to an aqueous dispersion in a way so substantial gelling or precipitation is avoided.

14. A process for the production of coated paper or paperboard comprising a step of applying a pigment composition to at least one side of a paper or paperboard web, said pigment composition being in the form of an aqueous dispersion comprising:
(a) pigment particles of synthetic amorphous silica or aluminosilicate;
(b) at least one water soluble aluminium salt; and,
(c) at least one cationic polymer having a molecular weight from about 2000 to about 1000000 and a charge density from about 0.2 to about 12 meq/g.

15. A process as claimed in claim 14, wherein the coating is applied in an amount sufficient to yield from about 0.4 g/m² to about 40 g/m² of pigment particles from the pigment composition per coated side of the paper or paper board web.

16. Coated paper or paper board produced by a process comprising a step of applying a pigment composition to at least one side of a paper or paperboard web, said pigment composition being in the form of an aqueous dispersion comprising:
(a) pigment particles of synthetic amorphous silica or aluminosilicate;
(b) at least one water soluble aluminium salt; and,
(c) at least one cationic polymer having a molecular weight from about 2000 to about 1000000 and a charge density from about 0.2 to about 12 meq/g.
